(19) United States
(12) Patent Application Publication
(10) Pub. No.: US 2021/0094798 A1
(43) Pub. Date: Apr. 1, 2021

(54) ELEVATOR SYSTEM, CONTROL UNIT FOR AN ELEVATOR SYSTEM, AND METHOD OF OPERATING AN ELEVATOR SYSTEM

(71) Applicant: thyssenkrupp Elevator Innovation and Operations AG, Essen (DE)

(72) Inventors: Richard Thum, Kornwestheim (DE); Marius Matz, Filderstadt (DE); Eduard Steinhauer, Nürtingen (DE)

(21) Appl. No.: 16/971,612

(22) PCT Filed: Feb. 14, 2019
(86) PCT No.: PCT/EP2019/053705

§ 371 Date: Aug. 20, 2020

(30) Foreign Application Priority Data
Feb. 20, 2018 (DE) 10 2018 202 551.7

(51) Int. Cl. B66B 5/00; B66B 9/00

(52) U.S. Cl. CPC B66B 5/0031; B66B 9/003

(57) ABSTRACT

An elevator system includes first and second intersecting elevator shafts having respective guide devices disposed therein to guide the elevator car. The intersection area of the shafts includes a third guide device that rotates with respect to the shaft walls between alignment with the first and second elevator shafts, to permit an elevator car to transfer from one elevator shaft to the other. A safety device triggers a blocking signal in a control unit to prevent movement of the third guide device if the extent, or footprint/area, of the elevator car spatially overlaps the intersection extent defined by the area over which the third guide device can be rotated in the intersection area. A method for operating the elevator system includes triggering a blocking signal to prevent movement of the third guide device if there is an overlap between the elevator car extent and the intersection extent.

The invention relates to a safety device for an elevator system having at least two elevator shafts which intersect to define an area of shaft intersection, an elevator system with a first elevator shaft and a second elevator shaft that intersects the first at a shaft intersection, and a method for operating an elevator system.

The invention can be used, for example, in elevator systems with at least one elevator car, in particular several elevator cars, which can be moved in a shaft via a guide device. At least one fixed first guide device is arranged fixedly in a first elevator shaft and is aligned in a first, in particular vertical, longitudinal direction of the shaft; at least one fixed second guide device is arranged fixedly in a second elevator shaft and aligned in a second, in particular horizontal, longitudinal direction of the shaft. The two elevator shafts intersect at a shaft intersection at which, in order to guide the elevator cars, at least one third guide device, which is rotatable relative to the first shaft and the second shaft, is fastened to a rotating platform that is fixed to the shaft intersection and can be rotated between an alignment in the first shaft direction and an alignment in the second shaft direction. Examples of such systems are basically described in WO 2015/144781 A1 and in the German patent applications 10 2016 211 997.4 and 10 2015 218 025.5.

When operating elevator systems, it is fundamentally necessary to prevent, in particular to avoid, undesired collisions of moving components of the elevator system, such as, for example, the elevator car, with permanently installed components, for example components which are fixed to a shaft. Elevator systems with a plurality of elevator cars in one shaft must also be able to reliably rule out collisions between the elevator cars. Proposed solutions to this are known, for example, from patent documents EP 1 698 580 A1 or EP 2 607 282 A1.

However, in the type of elevator systems described above, with intersecting elevator shafts, it is necessary to prevent potential collisions not only between successive elevator cars or elevator cars moving in opposite directions in a shaft longitudinal direction along a shaft axis. Rather, it must also be possible to prevent collisions between elevator cars which are traveling along different, intersecting elevator shafts.

In elevator systems of this type, it is often also desirable to be able to change the direction of travel of an elevator car at a shaft intersection. If such an operating case is to be provided, additional movable components, for example an alignable (third) guide device, for example a rotatable guide rail or another suitable guide device, are normally required at the shaft intersection. Such components harbor a potential risk of collision with the elevator car, in particular during their alignment movement and/or if their alignment is not matched to that guide device on which the elevator car approaches the alignable guide device. In addition to the risk of collision, there is also the risk of the elevator car being derailed if an alignment movement is started at a point in time at which the elevator car is partially guided on the alignable guide device.

Against this background, it is an object of the invention to provide a safety device and an improved elevator system which reduce a risk of collision between an elevator car and an alignable guide device and/or a risk of derailment for the elevator car. Likewise, a suitable method for operating an elevator system is to be provided.

This object is achieved by a safety device having the features of claim 1, an elevator system having the features of claim 3 and a method for operating an elevator system having the features of claim 8. Advantageous embodiments of the invention are the subject matter of the dependent claims.

According to one aspect of the invention, a safety device for an elevator system having at least two elevator shafts with different shaft axes is provided. The shaft axes and thus also the elevator shafts intersect at a shaft intersection, at which a guide device for elevator cars of the elevator system is arranged. The guide device can be rotated between an alignment along the shaft axis of the one elevator shaft and an alignment along the shaft axis of the other elevator shaft.

The safety device is configured to 1) determine a current extent of an elevator car of the elevator system and a possible intersection extent of the guide device, 2) compare the determined elevator car extent and the determined intersection extent, and 3) trigger a blocking signal for the alignment movement of the guide device in the event of an overlap between the elevator car extent and the intersection extent. A collision between the guide device and the elevator car and/or derailment of the elevator car owing to an alignment movement of the guide device can thus be prevented when the elevator car is already located in the area of the shaft intersection.

In order to also prevent, in particular avoid, collisions or derailments, if it is no longer possible to avoid the elevator car entering the area of the shaft intersection, according to one embodiment the safety device is configured to 4) determine an elevator car extent at a predicted stop position of the elevator car, starting from a current position and speed of the elevator car and in accordance with a predicted braking distance of the elevator car, 5) compare the determined elevator car extent at the stop position with the determined intersection extent of the guide device, and 6) trigger the blocking signal in the event of a predicted overlap between the elevator car extent and the intersection extent.

According to a further aspect of the invention, an elevator system is provided, comprising:

a) a first elevator shaft with a first guide device which is fixed to the shaft and parallel to a first, in particular vertical, shaft axis. The first guide device is in particular fixedly arranged in the first elevator shaft and aligned along the first shaft axis. The first guide device has in particular at least one first guide rail, on which one or more elevator cars can be guided along the first shaft axis in both first longitudinal directions through the first elevator shaft.

b) a second elevator shaft with a second guide device which is fixed to the shaft and parallel to a second, in particular horizontal, shaft axis. The second guide device is in particular fixedly arranged in the second elevator shaft and is aligned along the second shaft axis, wherein the second elevator shaft intersects the first elevator shaft at a shaft intersection. The shaft intersection is designed in particular in such a way that at said intersection elevator cars can pass (of course not simultaneously) along the first shaft axis or along the second shaft axis, possibly with an operational stop in the area of the shaft intersection. In addition, the shaft intersection is designed in particular in such a way that at said intersection an elevator car can change its direction of travel, i.e. for example: the elevator car arrives in the first shaft along the first shaft axis and continues along the second shaft axis in the second shaft (cf. in particular below c) with respect to the third guide device). The second guide device has in particular at least one second guide rail on which one or more elevator cars can be guided along the second shaft axis in both second longitudinal directions through the second elevator shaft.

c) at least one third guide device is arranged at the shaft intersection and is rotatable along an alignment path between an alignment in the first longitudinal shaft direction and an alignment in the second longitudinal shaft direction, wherein during the alignment the third guide device can assume, in particular in the area of the intended travel paths of an elevator car, in particular at most, a first intersection extent along the first shaft axis and a second intersection extent along the second shaft axis. An intersection extent along one of the shaft axes is not necessarily to be only understood as meaning an extent at a single point in time. Rather, this can also be understood to mean the entire area with respect to the shaft axis, along which the third guide device and/or an associated non-rotatable component, such as a rotating platform, extends at maximum, possibly also at different times. In particular, an intersection extent thus corresponds to an envelope geometry, relating to the corresponding shaft axis, of the third guide device, over the entire range of motion of said guide device during the alignment.

d) at least one elevator car which is movable along the, in particular first, second and/or third, guide devices with a first elevator car dimension along the first shaft axis and a second elevator car dimension along the second shaft axis. The elevator car can in particular be movable along at least two different shaft axes. A plurality of elevator cars are provided in particular in the elevator system. An elevator car dimension is to be understood in particular as a maximum extent of the elevator car along one of the shaft axes.

e) a control unit for controlling the elevator car and, in particular an alignment movement, of the third guide device, in particular along the alignment path. The control unit can in particular be embodied separately for the third guide device and/or as a logical and/or physical part of a control device of the elevator system. In particular, the control unit is a customary industrial controller and/or at least one component thereof. The control unit is in particular configured to monitor movement specifics of the elevator car and/or of the third guide device, for example by evaluating sensor values and/or operating models. The control unit and/or the elevator system also has a safety device according to an embodiment of the invention.

If in the following a property or a characteristic of the control unit is mentioned, this property or characteristic can also be attributed to the safety device, insofar as this makes sense. According to one embodiment, the control unit, in particular the safety device, is configured to
i) determine a position, in particular a travel position of the elevator car along the first and/or the second shaft axis. In particular, at least one position is determined along that shaft axis along which an elevator car moves toward a shaft intersection.
ii) determine an elevator car extent along the first and/or the second shaft axis on the basis of the first elevator car dimension and/or the second elevator car dimension, starting from the determined position of the elevator car. In particular, at least one elevator car extent is determined along that shaft axis along which an elevator car moves toward a shaft intersection.
iii) compare the determined elevator car extent with the first and/or the second intersection extent. The determined elevator car extent is in particular a projection of the elevator car onto the shaft axis under consideration; the determined intersection extent is in particular a maximum area along the corresponding shaft axis, along which an undesired collision between the elevator car and the third guide device is possible as result of an alignment movement.
iv) trigger a blocking signal for the alignment movement of the third guide device if the comparison shows an overlap between the elevator car extent on the one hand and the first intersection extent and/or the second intersection extent on the other.

According to one embodiment, the control unit, in particular the safety device, is configured to v) determine a velocity of the elevator car along the first and/or the second shaft axis; vi) determine a minimum and/or intended braking distance of the elevator car as a function of the determined the velocity; vii) determine a stop position of the elevator car as a function of the determined braking distance; viii) trigger the blocking signal for the alignment movement of the third guide device, in particular also if, at the determined stop position, an overlap is to be predicted between the elevator car extent on the one hand and the first intersection extent and/or the second intersection extent on the other. This is to be understood in particular to mean that the blocking signal is also triggered if there is no overlap between the elevator car extent and the intersection extent with respect to the relevant shaft axis at the time of detection, but owing to the movement specifics of the elevator car it is inevitable that it will enter the area of the intersection extent. This can be the case, for example, if maximum braking of the elevator car is also no longer sufficient to stop the elevator car before it reaches the intersection extent.

According to a further aspect of the invention, a method for operating an elevator system is provided, wherein the elevator system can be designed according to an embodiment of the invention. The method has at least the following method steps: i) determining a position of the elevator car along the first and/or the second shaft axis, ii) determining an elevator car extent along the first and/or the second shaft axis on the basis of the first elevator car dimension and/or the second elevator car dimension, starting from the determined position of the elevator car, iii) comparing the determined elevator car extent with the first and/or the second intersection extent, iv) triggering a blocking signal for the alignment movement of the third guide device, if the comparison shows an overlap between the elevator car extent on the one hand and the first and/or the second intersection extent on the other.

The invention is based, inter alia, on the knowledge that in elevator systems with intersecting elevator shafts, in which the elevator car can change direction at the corresponding shaft intersection, there are a large number of potential collision risks which do not occur in classic elevator systems with one elevator shaft.

In addition, the invention is based, inter alia, on the knowledge that in the event of changes in the direction of travel at the shaft intersection, these changes must normally be carried out by moving components, in particular by means of a third guide device, for example by means of third guide rails, which are arranged in a rotationally fixed manner on a rotating platform mounted on a shaft wall.

However, the alignment movement at the shaft intersection which is required to change the direction of travel creates a risk of damage owing to an alignment movement towards or away from the shaft intersection as the elevator car enters or exits. In order to reduce this risk of damage, according to the invention a comparison is carried out between the current extent of the elevator car and the maximum possible extent of the third guide device (and possibly components connected to it in a rotationally fixed manner, for example a rotating platform). If the comparison reveals a possibility of a collision, the blocking signal is triggered with respect to the alignment movement of the third guide device, for example to prevent, in particular to avoid, derailment of the elevator car or even damage to the elevator car guide and/or the third guide device.

In the present case, a blocking signal is to be understood to mean in particular a signal of the control unit, in particular the safety device, by means of which it is ensured that no alignment movement of the third guide device is triggered while the signal is present.

In the present case, a braking distance of the elevator car can also be understood in the sense of a stopping distance to mean the entire distance along an elevator shaft, which is required when braking becomes necessary in order to first determine the necessity (for example by means of the control unit) and then initiate braking and to bring it to a conclusion (for example by means of the control unit in cooperation with at least one brake element and/or gravity).

When an elevator car is referred to here, it is namely primarily an elevator car for transporting people and/or loads; however, the term elevator car also includes maintenance vehicles, breakdown vehicles, etc. in the elevator shaft, in particular those that can also be moved on the guide devices.

In order to facilitate a real-time control concept and/or an integration of the control of the third guide device into a superordinate control system of the elevator system, according to one embodiment the control unit, in particular the safety device, has access to an operating model, in particular to a control model and/or a state model of the elevator system, from which it is possible to determine: 1) the elevator car dimensions of the elevator car which are to be used for calculating the elevator car extent, and/or 2) the intersection extents of the third guide device and/or the rotating platform which are to be used, and/or 3) the braking distances of the elevator car which are to be used as a function of a velocity, and/or 4) the radial distance which is to be used for the components of the third guide device which extend furthest away from the axis of rotation of the third guide device and/or a component connected in a rotationally fixed manner such as a rotating platform, and/or 5) the elevator car contour which is to be used to determine an extent contour of the elevator car.

In particular, the control unit, in particular the safety device, can access at least one operating model of the elevator system and/or of the third guide device. This access can take place in particular through a wired or wireless connection to a database, the database being able to be stored, for example, in a memory of the control unit itself and/or on a company server and/or in a cloud-based memory.

An operating model of the elevator system and/or of the third guide device can be understood to mean, for example, a control model with a table in which various forms of at least one influencing variable (for example with an influence on the travel movement of the elevator car and/or the alignment movement of the third guide device) are respectively related to in each case at least one value of at least one control variable which is to be influenced by the control unit.

In the present case, for example, combinations of a position of the elevator car along a shaft axis and elevator car dimensions along this shaft axis can be linked on the one hand with a statement as to whether part of the intersection extent also lies along this elevator car extent. If this is the case, the blocking signal is triggered.

By means of such a control model, the control unit, in particular the safety device, can derive, depending on the determined combination of the elevator car extent and intersection extent how the third guide device is to be controlled, that is to say whether a blocking signal is required. The tables required for this can be derived, for example, from relationships between an influencing variable and a control variable determined experimentally and/or by means of computer models in the development phase and stored in the database, and can be part, for example, of a so-called ‘digital twin’ of the device.

Additionally or alternatively, an operating model of the elevator system and/or the third guide device can be understood to mean, for example, a state model with a table in which various occurrences of at least one auxiliary variable, on the occurrence of which at least indirectly an occurrence of an influencing variable (with influence on the elevator system and/or the third guide device) depends, are respectively related to at least one occurrence of this influencing variable in each case.

In the present case, for example, expressions of auxiliary variables such as a motor current, a motor torque and/or an increment of rotation angle of a drive motor of the elevator car can be linked to a statement about the position of the shaft axis at which the elevator car is currently being moved and the alignment speed. Such a state model can be used to determine a presently existing occurrence of the influencing variable, in particular even without resorting to sensor detection of occurrences of the influencing variable. The determined occurrence can then be fed, for example, into a control model of the operating model, in order to suitably control the elevator system and/or the third guide device. The tables required for this can be derived, for example, from relationships between an influencing variable and a control variable determined experimentally and/or by means of computer models in the development phase and stored in the database, and can be part, for example, of a so-called ‘digital twin’ of the device.

In order to further improve the collision safety, according to one embodiment, when the brake signal is triggered, the elevator car is switched to a safe operating state, in particular with the drive switched off and, if necessary, the maximum number of brakes applied.

In order to further improve the collision prevention and/or to facilitate access to an operating model, according to one embodiment, an intersection area of the third guide device is determined on the basis of the first intersection extent and the second intersection extent, and the blocking signal is triggered if an overlap is determined between the intersection area and the elevator car extent.

In order to further improve collision prevention, according to one embodiment, the intersection area is determined on the basis of a radial distance between the components of the third guide device that extend furthest away from the axis of rotation of the third guide device and/or a component that is non-rotatably connected thereto, such as the rotating platform, and is defined to form a circular area with this radius.

As a further safety factor, an extent contour of the elevator car can be determined according to one embodiment, in particular by means of an operating model, and compared with the circular area of the intersection area on the basis of the determined position of the elevator car, and the blocking signal can be triggered in the event of an overlap.

In order to relate collision avoidance not only to the currently detected collision risks, but also to collision risks that have already been created in the operating state and cannot be prevented, the method additionally comprises the following steps: v) determining a velocity of the elevator car along the first and/or the second shaft axis, vi) determining a minimum and/or intended braking distance (s) of the elevator car as a function of the determined velocity, vii) determining a stop position of the elevator car as a function of the determined braking distance, viii) triggering a blocking signal for the alignment movement of the third guide device if, at the determined stop position, an overlap is to be predicted between the elevator car extent on the one hand and the first and/or the second intersection extent on the other.

In order to permit a desired transfer of the elevator car from a first shaft direction to a second shaft direction or vice versa in spite of the collision protection, according to one embodiment the blocking signal is canceled again when the elevator car is at a designated point in the intersection area or comes to a stop there. Such a proposed location can in particular be defined by complete coverage of the intersection area by the elevator car extent and/or by an arrangement of the third guide device at a transfer point, in particular at a turning point, of the elevator car and/or preferably by overlapping of an axis of rotation of the third guide device and of an axis of rotation of the elevator guide.

For easier control of the blocking signal, the position and/or the velocity of the elevator car and/or the triggering of the blocking signal are/is determined in accordance with an operating model, in particular with a control model and/or with a state model, of the elevator arrangement and/or of the third guide device and/or of the elevator car.

In order for the invention to work in particular with a common type of guide arrangements such as a backpack guide, according to one embodiment the guide devices have at least one guide rail (and preferably consist of at least one guide rail), so that the third guide device has a third guide rail which for the purpose of alignment can rotate along an alignment path which is embodied as a rotating section and which is fixedly arranged on a rotating platform which is in particular at least indirectly attached to a shaft wall of the shaft intersection.

The term elevator shaft is used here only if the elevator shaft has its own boundary walls. For example, there are two elevator shafts in the present case if they are arranged parallel to one another without an intermediate wall and/or if they intersect one another without the shaft intersection being delimited by shaft walls. The term shaft relates in the present case also to the movement trajectory of the elevator car and is not purely limited to the presence of shaft walls.

Further features, advantages and possible uses of the invention result from the following description in conjunction with the figures. In the figures:

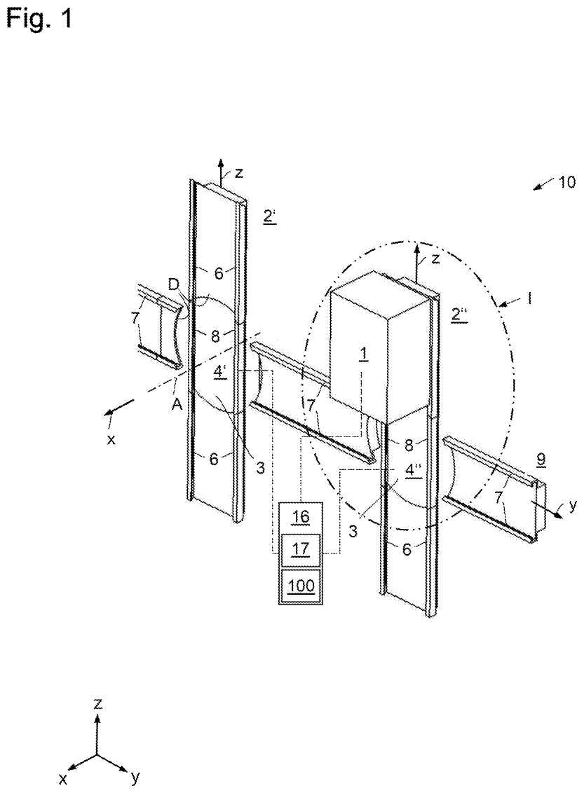

FIG. 1 shows a schematic oblique view of the basic structure of an elevator system with a safety device according to an exemplary embodiment of the invention, and;

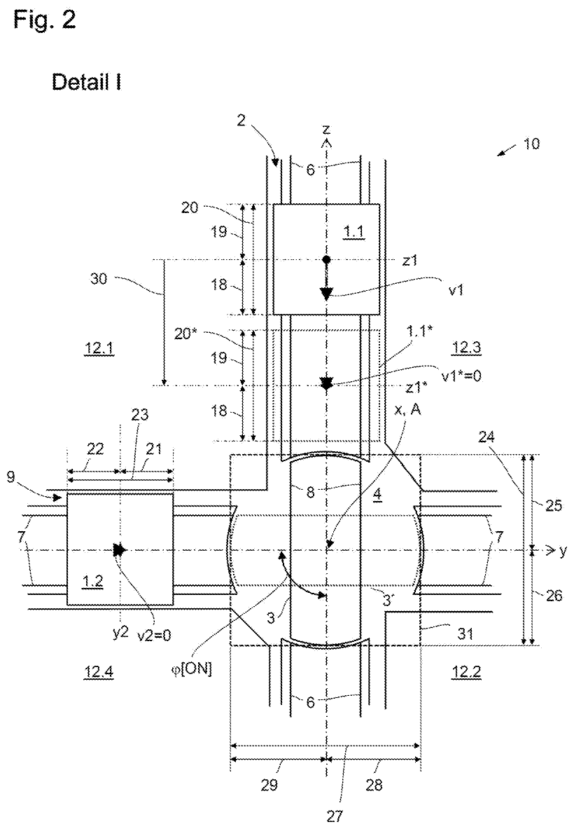

FIG. 2 shows, in a schematic side view, the area of the elevator system marked in FIG. 1 with a shaft intersection in a first operating case of the safety device, in which, according to a first exemplary method, no blocking signal for the alignment movement is triggered;

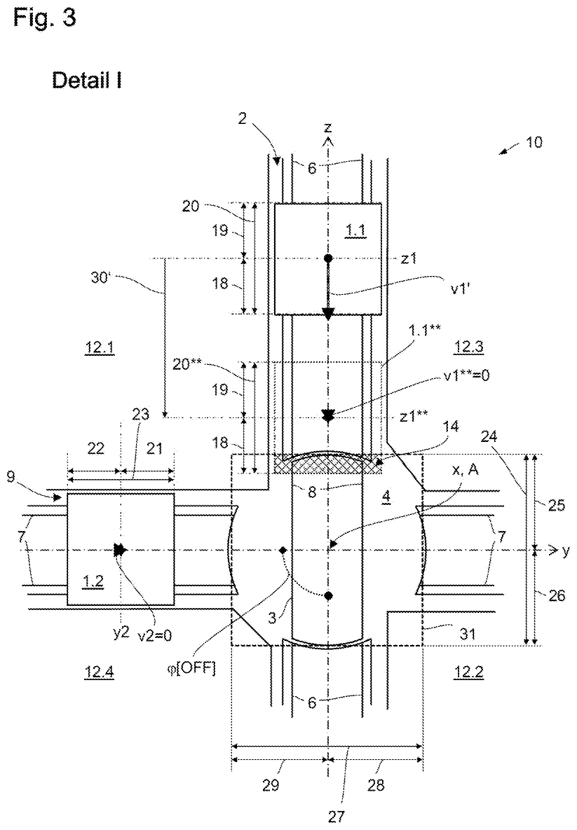

FIG. 3 shows the schematic side view from FIG. 1 in a second operating case of the safety device, in which a blocking signal is triggered in accordance with the first exemplary method; and

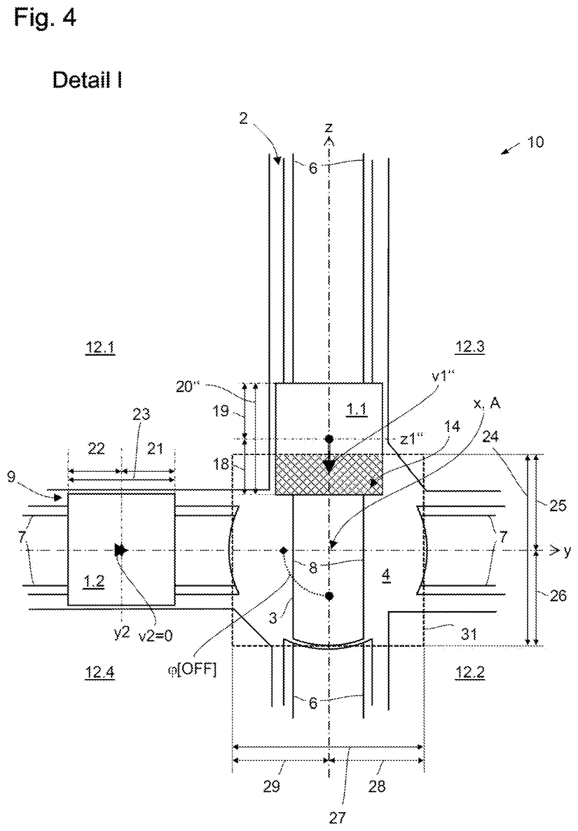

FIG. 4 shows the schematic side view from FIGS. 1 and 2 in a third operating case of the safety device, in which a blocking signal is triggered in accordance with a second exemplary method.

FIG. 1 shows parts of an elevator system 10 according to the invention. The elevator system 10 comprises fixed first guide devices 6 embodied as guide rails, along which an elevator car 1 can be guided by means of backpack mounting. The first guide devices 6 are aligned vertically in a first direction z and make it possible for the elevator car 1 to be moved between different floors. Arranged parallel to one another in two parallel first vehicle shafts 2′, 2″ are arrangements of such first guide devices 6, along which the elevator car 1 can be guided using backpack mounting. Elevator cars in one shaft 2′ can move on the respective first guide devices 6, largely independently and unhindered by elevator cars 1 in the other shaft 2″.

The elevator system 10 further comprises fixed second guide devices 7, embodied as guide rails, along which the elevator car 1 can be guided using backpack mounting. The second guide devices 7 are aligned horizontally in a second direction y and make it possible for the elevator car 1 to be movable within a floor. The second guide devices 7 also connect the first guide devices 6 of the two shafts 2′, 2″ to one another. Thus, the second guide devices 7 also serve to transfer and relocate the elevator car 1 between the two shafts 2′ and 2″, in order, for example, to implement a modern paternoster operation.

In the exemplary embodiment, the second guide devices 7 run along a second elevator shaft 9 which intersects the two first elevator shafts 2′ and 2″ at a respective shaft intersection 4′ and 4″. In other exemplary embodiments in the sense of the invention, the shaft intersection can also be embodied in the form of a T junction.

At these shaft intersections 4′ and 4″, the elevator car 1 can be respectively rotated from the first guide devices 6 onto the second guide devices 7 and vice versa, in each case via third guide devices 8 embodied as guide rails. The third guide devices 8 are rotatable with respect to an axis of rotation A which is perpendicular to a y-z plane (and thus parallel to an x axis of the elevator system) which is spanned by the first and the second guide devices 6, 7.

All the guide rails 6, 7, 8 are at least indirectly attached to at least one shaft wall of a shaft 2 and/or a shaft 9. The shaft wall defines in particular a stationary reference system for the shaft. The term shaft wall also in particular alternatively includes a stationary frame structure of the shaft which carries the guide rails. The rotatable third guide rails 8 are fastened to a rotary platform 3.

Such systems are basically described in WO 2015/144781 A1 and in the German patent applications 10 2016 211 997.4 and 10 2015 218 025.5. In this context, 10 2016 205 794.4 describes in detail an arrangement with an integrated platform pivot bearing and a drive unit for rotating the rotating platform 3, which can also be used, for example, as part of the present invention for mounting and as a rotary drive for the rotating platform 3.

FIGS. 2, 3 and 4 each show the detail I of the elevator system 10 presented by a double-dotted chain line in FIG. 1. While only a single elevator car 1 is shown in FIG. 1 in order to provide a clearer representation, FIGS. 2-4 show a first elevator car 1.1, which is arranged along a first, vertical elevator shaft 2 at the illustrated time of operation, and a second elevator car 1.2, which is arranged along a second, horizontal elevator shaft 9 at the illustrated time of operation.

FIGS. 2-4 each show a shaft intersection 4 (here the shaft intersection 4″ from FIG. 1) and the surroundings of the elevator system 10, wherein the shaft intersection 4 is formed at an interface of the first elevator shaft 2 and of the second elevator shaft 9. The elevator shafts 2 and 9 are delimited by the shaft walls 12.1, 12.2, 12.3 and 12.4 illustrated in a simplified form.

In the first elevator shaft 2, first guide devices 6 are arranged, on which, at the illustrated time, the elevator car 1.1 is movably mounted with an elevator car guide (not illustrated). In the second elevator shaft 9, second guide devices 7 are arranged, on which, at the illustrated time, the elevator car 1.2 is movably mounted with an elevator car guide (likewise not illustrated). Within the area of the shaft intersection 4 is disposed a rotating platform 3, on which third guide devices 8 are affixed in a rotationally fixed manner. The rotating platform 3 is configured to be rotated along an alignment path φ between an alignment in the vertical shaft direction z—as it were as a bridge between the upper and lower first guide devices 6 on the one hand—and an alignment in the horizontal shaft direction y—as it were as a bridge between the left and right-hand second guide devices 7 on the other. The safety device 100 is configured to allow an alignment movement of the rotating platform 3 (cf. reference symbol φ[ON]) or to prevent it by means of a blocking signal φ[OFF].

The first elevator car 1.1 has—starting from a reference point which in the exemplary embodiment corresponds to an axis of rotation of the elevator car guide (not illustrated) and at which a current position z1 of the elevator car 1.1 in the shaft 2 can be determined—a first elevator car dimension of 18 along the vertical shaft axis z, toward the shaft intersection 4 and an elevator car dimension of 19 away from the shaft intersection 4. The same applies to the second elevator car 1.2 with respect to the horizontal shaft axis y, for a current position y1 and for second elevator car dimensions 21 toward the shaft intersection and second elevator car dimensions 22 away from the shaft intersection 4.

The rotating platform 3 with the third guide devices 8 has a first intersection extent 24 with respect to the vertical shaft axis z, which intersection extent 24 is composed of an upper part 25 and a lower part 26. With regard to the horizontal shaft axis y, the rotating platform 3 with the third guide devices 8 has a second intersection extent 27, which is composed of a right-hand part 28 and a left-hand part 29. The two intersection extents 24 and 27 delimit an, in the example, rectangular intersection area 31 which in the present case as a rectangular envelope surface of all the points in the illustrated sheet plane, for the alignable components 3, 8, which can be reached by the aligning movement.

In FIGS. 2-4, the rotating platform 3 is aligned with the third guide devices 8 in the vertical shaft axis z. The elevator car 1.2 in the horizontal shaft 9 is accordingly subject to a stop signal from the control unit 16 at the point in time shown, because entry into the shaft intersection 4 is in any case not possible or permitted owing to the alignment of the rotating platform 3. This is respectably indicated in FIGS. 2-4 by the symbol denoted by v2=0.

The elevator car 1.1 in the vertical shaft 2 is not subject to this stop signal because the rotating platform 3 has been aligned with the first guide devices 6. Entry into the shaft intersection 4 is therefore possible per se. At the illustrated point in time, the elevator car 1.1 moves from its current position z1 at a speed v1 down along the shaft axis z. In the various operating cases in FIGS. 2, 3 and 4, the movement optionally takes place at different speeds v1.

In FIGS. 2-4, different operating cases of an exemplary safety device 100 of an exemplary elevator device 10 according to FIG. 1 are explained in more detail below using partly different exemplary operating methods. FIGS. 2 and 3 show different operating cases in the same exemplary method; FIG. 4 shows an operating case of another exemplary method. The control unit 16 and/or the safety device 100 can determine required influencing and/or state variables of the elevator system 10 by means of suitable access to an operating model 17, in particular to a control model and/or a state model.

The aim of all of the exemplary methods presented is to determine in each case whether—regardless of other collision risks in the elevator system 10—a collision between a third guide device 8 (and/or possibly the rotating platform 3 connected to it in a rotationally fixed manner) on the one hand and the elevator car 1.1 (or one of its components) on the other and/or derailment of the elevator car 1 are/is to be feared if an alignment movement of the rotating platform 3 with the third guide devices 8 were to take place at or after the illustrated point in time. Accordingly, the implementation of each of the methods enables a decision to be made as to whether a blocking signal φ[OFF] for the alignment movement of the third guide devices 8 has to be triggered, in order to prevent such a risk, or not (φ[ON]).

In the first operating case according to FIG. 2, i) a position z1 of the elevator car 1.1 along the first and/or the second shaft axis z is first determined by means of the safety device 100 (possibly using the required functionality of the control unit 16). ii) Starting from the determined position of the elevator car 1.1, an elevator car extent 20 along the first shaft axis z is then determined on the basis of the first elevator car dimensions 18 and 19. iii) The determined elevator car extent is compared with the first intersection extent 24, it being determined in the comparison iv) whether there is an overlap between the elevator car extent 20 on the one hand and the first intersection extent 24 on the other, along the vertical shaft axis z. In the illustrated operating case, this is not the case at the illustrated point in time. For this reason, no blocking signal φ[OFF] for the alignment movement is triggered on the basis of this examination; φ[ON] still applies for the alignment movement.

In a second part of the method, an additional check is carried out to determine whether such an overlap can no longer be prevented, in particular avoided, owing to the present velocity v1 of the elevator car 1.1, even though it is not yet present.

For this purpose v) first the current velocity v1 of the elevator car 1.1 along the first shaft axis z is determined. vi) Depending on the determined velocity, either a minimum braking distance 30 of the elevator car 1.1 or a braking distance 30 of the elevator car 1.1, which is possibly provided for the current operating case, is determined. vii) Depending on the determined braking distance, a stop position z1* of the elevator car 1.1 is determined. In particular, analogously to step ii) from the first method part i)-iv), an expected location of elevator car extent 20* is determined on the basis of the determined stop position z1*. vii) At the determined stop position z1*, a comparison is carried out for the elevator car 1.1* to determine whether an overlap is expected to occur between the elevator car extent s* on the one hand and the first intersection extent 24 on the other. In the illustrated operating case, this is not the case at the illustrated point in time. For this reason, no blocking signal φ[OFF] for the alignment movement is triggered on the basis of this examination; φ[ON] still applies for the alignment movement.

The first part of the process i)-iv) and the second part of the process v)-viii) are repeated many times per second, so that the possibility of aligning the third guide devices 8 on the rotating platform 3 can be maintained for as long as possible until a risk of collision owing to an alignment movement can no longer be excluded.

In the second operating case according to FIG. 3, the same exemplary method as for the first operating case (according to FIG. 2) is carried out. The second operating case differs from the first operating case at least by a speed v1′ of the elevator car 1.1, which is higher in comparison to speed v1 from the first operating case.

Accordingly, the check according to the first method part i)-iv) does not produce a different result for the second operating case, because the speed v is not taken into account here.

However, the check according to the second method part v)-viii) results in a longer braking distance 30′ (step vi) due to the higher speed v1′. This results in a predicted stop position z1′ of the elevator car 1.1** which is closer to the shaft intersection 4 (step vii). Correspondingly, in the comparison according to step viii), an overlap 14 (see hatched area) is determined between the elevator car extent s′ and the intersection extent 24.

Accordingly, a blocking signal φ[OFF] for the alignment movement or the alignment path φ of the third guide device is triggered in order to prevent the potential collision between a moving guide device 8 and the elevator car 1.1 which inevitably enters the viewing area.

In the third operating case according to FIG. 4, an exemplary method is carried out which only contains the first method part i)-iv). In the third operating case, this is also sufficient because the implementation of these method steps is already sufficient to determine an overlap 14 between the elevator car extent 20 and the intersection extent 24.

The third operating case differs from the first two operating cases in particular by a position z1″ of the elevator car 1.1 closer to the shaft intersection 4 at the examined time. Regardless of the speed v1″ at which the elevator car 1.1 is moving at this point in time, the result of this position is that there is already an overlap 14 at the current point in time, and consequently the blocking signal φ[OFF] for the alignment movement φ of the third guide device 8 is triggered.

In this case there is no need to carry out the second part of the method v)-viii). Such a method will probably be carried out in particular as an initial test for a recording, then in the normal case probably with the elevator car stationary.

The described methods and operating cases can of course also be applied analogously to movements of the other elevator car 1.2 along the horizontal guide devices 7 if the rotating platform 3 is aligned accordingly. In this case, the reference variables used include, inter alia, the position y2 of the elevator car 1.2, its speed v2, the elevator car extent 23 and the intersection extent 27, each along the horizontal shaft axis y.

For all of the operating cases described, it can be provided in the exemplary embodiment that the corresponding method continues to be carried out many times per second and the blocking signal is released (φ[OFF]→φ[ON]), as soon as there is either no longer any overlap or an alignment axis of the elevator car 1 and the axis of rotation A of the rotating platform 3 are congruent, in particular for common alignment.

### LIST OF REFERENCE DESIGNATIONS

1 Elevator car
2 First elevator shaft (for example vertical)
3 Rotating platform
4 Shaft intersection
6 First guide device (for example guide rail)
7 Second guide device (for example guide rail)
8 Third guide device (for example guide rail)
9 Second elevator shaft (for example horizontal)
10 Elevator system
12 Shaft wall
14 Overlap between elevator car extent and intersection extent
16 Control unit
17 Operating model
18, 19 First elevator car dimensions
20 Elevator car extent along the vertical shaft axis
21, 22 Second elevator car dimensions
23 Elevator car extent along the horizontal shaft axis
24 First intersection extent
25, 26 Parts of the first intersection extent
27 Second intersection extent
28, 29 Parts of the second intersection extent
30 Braking distance of the elevator car
31 Intersection area
100 Safety device
φ Alignment path
φ[OFF] blocking signal for the alignment movement
v Speed of an elevator car
x; A Depth axis of the elevator car; axis of rotation of the third guide device
y Extent axis of a second elevator shaft
z Extent axis of a first elevator shaft
z1, y2 position of an elevator car

1.-11. (canceled)

12. A control unit for controlling actions of an elevator system, the elevator system having at least a first elevator shaft with a first axis and a second elevator shaft with a second axis, which first and second elevator shafts intersect to define an area of a shaft intersection, at which shaft intersection is disposed a rotatable guide device along which elevator cars of the elevator system travel, wherein the guide device is rotatable so as to be selectively oriented in alignment with the first axis of the first elevator shaft or in alignment with the second axis of the second elevator shaft, the control unit comprising:
a safety device in operative communication with, and configured to control, each of the elevator car and movement of the moveable guide device, and further configured to:
determine a current extent of an elevator car of the elevator system and an intersection extent of the guide device,
compare the current extent of the elevator car to the intersection extent to check if there is any spatial overlap between the elevator car extent and the intersection extent, and
trigger a blocking signal in the control unit to prevent movement of the guide device out of alignment with either the first or second axis when the comparison indicates the existence of a spatial overlap between the elevator car extent and the intersection extent.

13. The control unit of claim 12, wherein the safety device is further configured to:
determine a predicted elevator car extent at a calculated stop position of the elevator car, based on a current position, a current speed, and a calculated braking distance of the elevator car, the calculated stop position and calculated braking distance being generated in an electronic operating model of the elevator car,
compare the predicted elevator car extent at the calculated stop position to the determined intersection extent of the guide device to check if there will be a spatial overlap between the elevator car extent and the intersection extent when the elevator car arrives at the calculated stop position, and
trigger the blocking signal in the control unit to prevent movement of the guide device out of alignment with either the first or second axis, when the comparison indicates that there will be an expected overlap between the elevator car extent and the intersection extent.

14. An elevator system, comprising:
a first elevator shaft having a first guide device affixed thereto and disposed parallel to a first shaft axis,
a second elevator shaft having a second guide device affixed thereto and disposed parallel to a second shaft axis, wherein the second elevator shaft and the first elevator shaft intersect to define an area of shaft intersection,
a third guide device disposed within the area of the shaft intersection and rotatable about an axis of rotation between alignment with the first shaft axis and alignment with the second shaft axis, wherein the third guide device extends across a full length of the first intersection extent when rotated into alignment with the first shaft axis, and extends across a full length of the second intersection extent when rotated into alignment with the second shaft axis,
an elevator car that is movable along any of the first, second, or third guide devices, having a first elevator car dimension defined along the first shaft axis and a second elevator car dimension defined along the second shaft axis,
a control unit in operative communication with, and configured to control each of the elevator car and movement of the third guide device, the control unit comprising a safety device configured to:
determine a current extent of the elevator car and an intersection extent of the third guide device,
compare the current extent of the elevator car to the intersection extent to check if there is any spatial overlap between the elevator car extent and the intersection extent, and
trigger a blocking signal in the control unit to prevent a movement of the third guide device out of alignment with either the first or second axis when the comparison indicates the existence of a spatial overlap between the elevator car extent and the intersection extent.

15. The elevator system of claim 14, wherein the safety device is further configured to:
determine a current position of the elevator car along the first and/or second shaft axis,
determine an elevator car extent along at least one of the first or second shaft axis based on at least one of the respective first elevator car dimension or the second elevator car dimension, starting from the determined current position of the elevator car,
compare the determined elevator car extent to the respective first or the second intersection extent to check for any overlap between the determined elevator car extent and respective first or second intersection extent, and
trigger a blocking signal in the control unit to prevent movement of the third guide device out of alignment with either the first or second axis when the comparison indicates the existence of a spatial overlap between the elevator car extent and the respective first or second intersection extent.

16. The elevator system of claim 14, wherein the safety device is further configured to:
determine a velocity of the elevator car along the first and/or the second shaft axis,
determine one of a selected braking distance of the elevator car as a function of the determined velocity,
determine a stop position of the elevator car as a function of the selected braking distance,
trigger a blocking signal in the control unit to prevent movement of the third guide device out of alignment with either the first or second axis when, at the determined stop position, the safety device determines that a spatial overlap will occur between the elevator car extent and respective of the first intersection extent and/or the second intersection extent.

17. The elevator system of claim 16, wherein each of the first, second, and third guide devices comprise guide rails, wherein the third guide device comprises a third guide rail fixedly disposed on a rotating platform, which rotating platform is rotatably attached to a shaft wall within the area of shaft intersection and rotates with respect to the shaft wall.

18. The elevator system of claim 17, wherein the safety device is configured to access an operating model from which the safety device can determine one or more of:
the dimensions of the elevator car,
the intersection extents of the third guide device and/or the rotating platform, the braking distances of the elevator car as a function of a velocity of the elevator car,
a maximum radial distance from the axis of rotation to the farthest extending point on the rotatable third guide device, and
an elevator car contour used to determine an extent contour of the elevator car.

19. A method of operating an elevator system, comprising:
providing an elevator system as described in claim 14;
determining a position of a reference point of the elevator car along the first and/or the second shaft axis,
determining an elevator car extent along the first and/or the second shaft axis based on the first elevator car dimension and/or the second elevator car dimension, starting from the determined position of the reference point of the elevator car,
comparing the determined elevator car extent with the first and/or the second intersection extent to check if there is any spatial overlap between the elevator car extent and the respective first and/or second intersection extent,
triggering a blocking signal in the control unit to prevent a movement of the third guide device out of alignment with either the first or second axis, if the comparison shows that an overlap exists between the elevator car extent and the respective first and/or second intersection extent.

20. The method of claim 19, further comprising:
determining a velocity of the elevator car along the first and/or the second shaft axis;
determining a selected braking distance of the elevator car as a function of the determined velocity;
determining a stop position of the elevator car as a function of the selected braking distance;
triggering a blocking signal in the control unit to prevent movement of the third guide device if, at the determined stop position, the safety device determines that an overlap will occur between the elevator car extent and respective of the first and/or the second intersection extent.

21. The method of claim 19, further comprising:
canceling the blocking signal when the elevator car moves to, or comes to a stop at, a designated point in the shaft intersection area.

22. The method of claim 19, wherein at least one of the position of the elevator car, the velocity of the elevator car, or the triggering of the blocking signal is determined based on an operating model of at least one of the elevator system, the third guide device, or the elevator car.
